(19) United States
(12) Patent Application Publication
(10) Pub. No.: US 2007/0050906 A1
(43) Pub. Date: Mar. 8, 2007

(54) Multifeature foot spa

(76) Inventors: Martin A. Cohen, Ridgefield, CT (US); Vito James Carlucci, Stratford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/301,881

(22) Filed: Dec. 13, 2005

Related U.S. Application Data
(63) Continuation-in-part of application No. 10/661,006, filed on Sep. 11, 2003.
(60) Provisional application No. 60/410,454, filed on Sep. 13, 2002.
(60) Provisional application No. 60/410,965, filed on Sep. 16, 2002.

(51) Int. Cl. A47K 3/022; A61H 35/00; E03C 1/00

(52) U.S. Cl. 4/622

(57) ABSTRACT

A foot spa and a method for controlling the foot spa is provided. The foot spa has a housing defining a reservoir for retaining a volume of fluid, and a lid selectively covering a portion of the reservoir. The foot spa can have any combination of a remote control unit for generating a signal for controlling a plurality of functions of the foot spa, a receiver for receiving the control signal, a retractable cord, an infrared heater, an in-line fluid heater, adjustable fluid jets, a spinning massage attachment function, and a control assembly operable by the foot of the user.

### CROSS-REFERENCE TO RELATED APPLICATIONS

This is a continuation-in-part application and claims priority to U.S. application Ser. No. 10/661,006, filed on Sep. 11, 2003, which claims priority in co-pending U.S. Provisional Patent Application Ser. No. 60/410,454 filed on Sep. 13, 2002, and co-pending U.S. Provisional Application Ser. No. 60/410,965, filed Sep. 16, 2002, the disclosures of which are incorporated herein by reference.

### BACKGROUND OF THE INVENTION

1. Field of the Invention

The present invention relates to foot spas. More particularly, the present invention relates to a foot spa having a number of therapeutic and convenient features incorporated into a single foot spa unit.

2. Description of the Related Art

In the prior art, there are known foot therapy massagers for providing a variety of vibrating massage sensations, both with or without fluid, and aerated bubble massage sensations, either alone or in combination. Generally, a common objective in the prior art devices is to provide relief to a user by providing soothing, therapeutic stimuli to the user's feet.

However, operation of the prior art foot therapy devices is characterized by inconvenience and requires manipulation of controls located on the foot therapy devices. Thus, any soothing, and relaxing therapeutic benefit(s) gained by use of the foot therapy device must necessarily be interrupted in order to control the device. Also, only one or two types of therapy are incorporated into the heretofore foot spas for providing relief to the user. Further, these conventional foot therapy devices are typically made from material having limited temperature tolerances, such as plastic or polymeric material. These devices suffer from poor overall heat transfer, longer heat-up time requirements, and an inability to maintain an appropriate/desired level of heat.

Therefore, there exists a need to provide a foot spa that is easily controlled and operated, unlimited by controls attached or connected to the foot spa therapy, and offering numerous types of therapeutic relief, as well as improved thermal efficiency.

### SUMMARY OF THE INVENTION

It is an object of the present invention to provide a foot spa that provides therapeutic tactile sensations to aid in the overall relaxation and well-being to a user.

It is another object of the present invention to provide such a foot spa that is suitable to retain and heat a fluid with improved thermal efficiency.

It is yet another object of the present invention to provide such a foot spa to efficiently move fluid from a bottom wall of the basin of the foot spa and dispose the fluid to a point above the bottom wall, thereby creating the jetting action for massaging feet.

It is still another object of the present invention to provide a foot spa having remote activation and control capabilities.

It is still yet another object of the present invention to provide a foot spa that can be operated by the foot of a user.

It is a further object of the present invention to provide such a foot spa having a retractable cord.

It is still a further object of the present invention to provide such to a foot spa that has a housing defining a reservoir for retaining a volume of fluid, and a lid partially covering a portion of the reservoir. The foot spa can have all or any combination of the following: a wireless remote control unit for generating a signal for controlling a plurality of functions of the foot spa, a receiver for receiving the control signal, a retractable cord, an infrared heater, an in-line fluid heater, adjustable fluid jets, a spinning massage attachment function, and a control assembly operable by the foot of the user.

In accordance with the teachings of the present invention, the foot spa generally has a housing with a foot supporting bottom wall with sidewalls extending upwardly therefrom to form a reservoir for receiving and retaining a fluid. The fluid is preferably water. The foot spa also has a heater for heating the fluid as desired by a user. The heater may include an inline heater. A fluid transport assembly is provided for transporting the fluid from the bottom wall of the reservoir to a point above the bottom wall of the reservoir. Preferably, the fluid transport assembly is disposed within the housing and cooperates with the heater. The fluid transport assembly is operatively connected to a fluid inlet preferably located in or near the bottom wall or lower portion of the walls of the foot spa. The fluid transport assembly is also operatively connected to a fluid outlet disposed above and in spaced relation to the bottom wall of the reservoir. The fluid outlet and the reservoir bottom wall define a foot receiving space therebetween.

The above and other objects, advantages, and benefits of the present invention will be understood by reference to following detailed description and appended sheets of drawings.

### BRIEF DESCRIPTION OF THE DRAWINGS

FIG. 1 is a top perspective view of a foot spa in accordance with an illustrative embodiment of the present invention;

FIG. 2 is a top plan view of the foot spa shown in FIG. 1;

FIG. 3 is a partial side section view of the foot spa shown in FIG. 1;

FIG. 4 is a perspective view of a number of illustrative stimulus attachments for use in conjunction with the foot spa shown in FIG. 1;

FIG. 5 is a top view of a control panel associated with the foot spa shown in FIG. 1 in accordance with an illustrative embodiment of the present invention;

FIG. 6 is a side section view of the control panel shown in FIG. 5;

FIG. 7 is a bottom perspective view of the foot spa shown in FIG. 1 with the outer housing removed;

FIG. 8 is a blown-up bottom perspective view of the foot spa of FIG. 7 showing an inner center portion thereof;

FIG. 9 is another bottom perspective view of the foot spa of FIG. 7;

FIG. 10 is a front view of an alternative heater assembly for the foot spa of FIG. 1;

FIG. 11 is a side view of the heater assembly of FIG. 10;

FIG. 12 is a bottom view of the heater assembly of FIG. 10;

FIG. 13 is a rear view of the heater assembly of FIG. 10;

FIG. 14 is a top view of the heater assembly of FIG. 10;

FIG. 15 is a side cross-sectional view of the heater assembly of FIG. 10, taken along line A-A of FIG. 14;

FIG. 16 is a detailed view of portion I of the heater assembly of FIG. 15;

FIG. 17 is a top perspective view of an alternative heater assembly for the foot spa of FIG. 1;

FIG. 18 is a top view of a remote control for remotely operating the foot spa of FIG. 1;

FIG. 19 is a perspective view of the foot spa of FIG. 1 with a receptacle for receiving and retaining the remote control of FIG. 18;

FIG. 20 is a top plan view of exemplary foot bed inserts for use in conjunction with the foot spa of FIG. 1; and

FIG. 21 is a bottom plan view of an exemplary cord reel feature associated with the foot spa shown of FIG. 1.

FIG. 22A is a top exploded view of an exemplary cord reel feature associated with the foot spa shown in FIG. 1.

FIG. 22B is a bottom exploded view of an exemplary cord reel feature associated with the foot spa shown in FIG. 1.

### DETAILED DESCRIPTION OF THE INVENTION

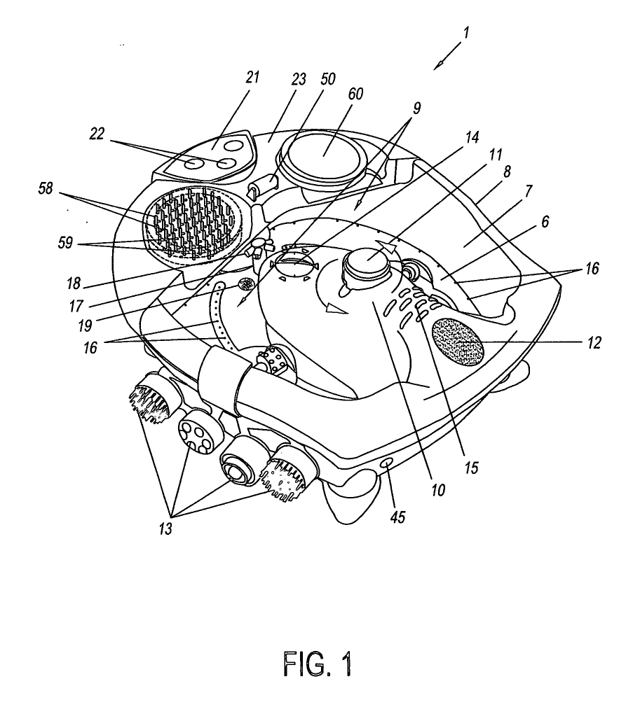

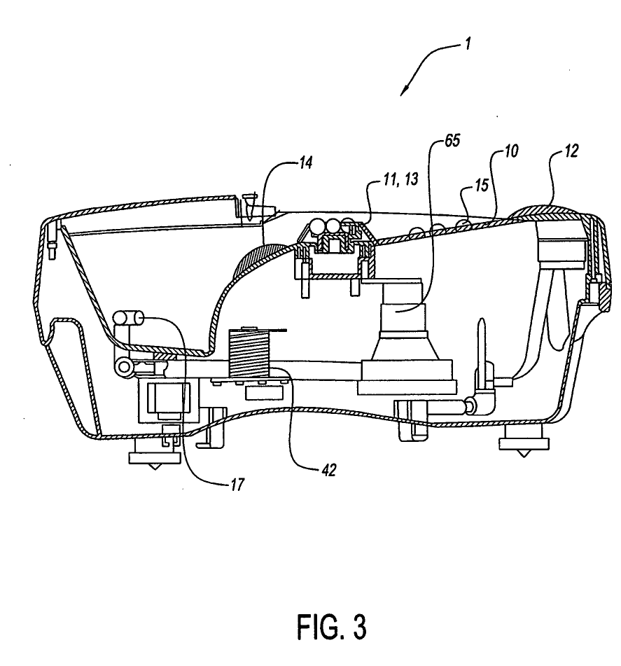

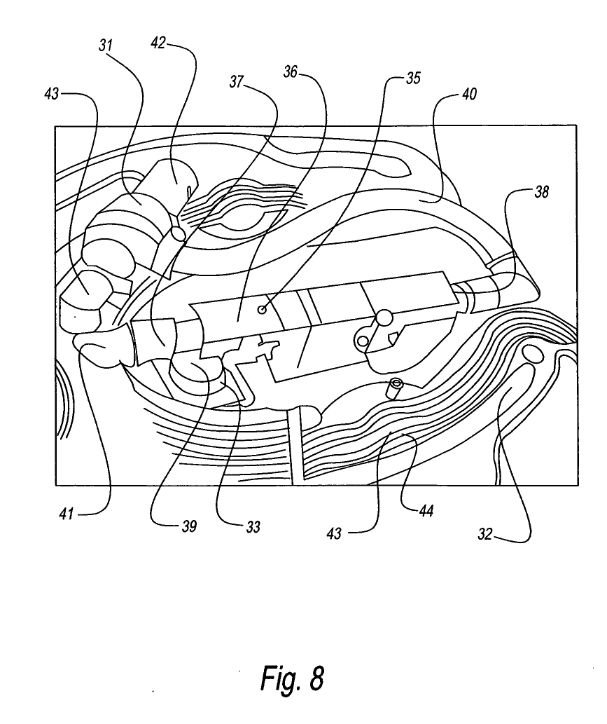

Referring to the drawings and in particular FIG. 1, there is provided a foot spa generally represented by reference numeral 1. Referring to FIGS. 1 through 9, foot spa 1 has a housing 5, a heater 30, a fluid transport assembly 65, and a number of other therapeutic features. The various therapeutic features and other aspects of foot spa 1 will be identified and discussed hereafter in detail.

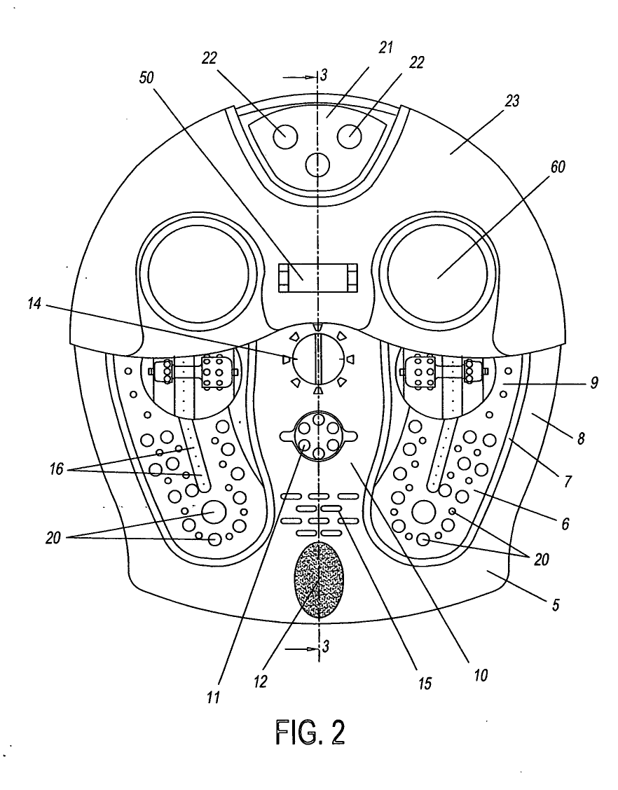

Referring to FIGS. 1 and 2, housing 5 preferably has a floor or bottom wall 6, sidewalls 7, and a cover or top wall 8, with the bottom wall and sidewalls, and preferably all three, defining a reservoir 9. The reservoir 9 preferably provides for the placement of feet for therapeutic massaging therein and for optionally holding fluid. Housing 5 preferably forms a cup-like shape with reservoir 9. Housing 5 can have a heel rest or a raised portion 10 preferably dividing reservoir 9 into two substantially separate portions, one for each foot of the user, and providing an area on which the user may rest his/her feet. Raised portion 10 preferably accommodates an infrared heater 12, an attachment receptor 11 for cooperating with various stimulus attachments 13, and a heat control 14.

In the embodiment shown in FIGS. 1 and 2, housing 5 has a raised surface with infrared heater 12 thereon. Infrared heater 12 is preferably capable of providing infrared heat therapy to the foot of a user placed on/above the infrared heater. Also, the raised surface with infrared heater 12 preferably provides a slip-resistant surface for placement of feet thereon when receiving infrared heat therapy from the infrared heater and/or massaging action from stimulus attachments 13. Further, the raised surface can have apertures 15 to emit and/or receive fluid therefrom. For example, air can be emitted therefrom to dry or otherwise influence the foot of the user. Alternatively, or in addition, apertures 15 can be suitable for allowing fluid dripping from the user's feet to drain through the raised surface and into reservoir 9 instead of collecting on a top surface thereof.

It should be appreciated that other therapy delivery units may be incorporated into foot spa 1 in addition to, in combination with, or in lieu of infrared heater 12 and stimulus attachments 13. For example, a stone therapy unit having a stone surface capable of being heated for providing hot stone therapy and/or an ionic generator/emitter for generating charged ions and providing ionic therapy may be incorporated into foot spa 1. The stone therapy unit and the ionic generator/emitter (as well as any other types of therapy delivery units) may be disposed on any part of housing 5 in a position uncovered by fluid even when fluid is disposed in reservoir 9.

In one aspect of the present invention, the stone therapy unit and the ionic generator (as well as any other types of therapy delivery units, such as, for example, stimulus attachments 13) may be disposed on bottom wall 6 and/or sidewalls 7, in a position that may be covered by fluid when fluid is optionally placed in reservoir 9.

Preferably, attachment receptor 11 is connected to a rotating shaft of a motor disposed in housing 5 of foot spa 1. Various stimulus attachments 13 can preferably be connected to the rotating shaft of the motor (not shown) via attachment receptor 11. Operatively, stimulus attachments 13 can removably engage attachment receptor 11 for, at the user's option, providing therapeutic stimulus to a foot placed thereon. In one aspect hereof, stimulus attachments 13 are rotated by being depressed. That is, stimulus attachments 13 are preferably activated or set into a spinning motion upon being depressed.

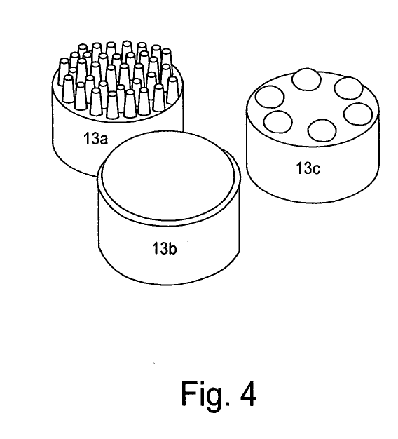

FIGS. 1 and 4 show exemplary spinning attachments for use in conjunction with foot spa 1. These spinning attachments can be, for example as shown in FIG. 4, a bristled massager 13a, a pumice stone 13b and/or a gentle massager 13c. Although not shown, it should be appreciated by those skilled in the art that other spinning attachments may be used in connection with foot spa 1, such as, but not limited to, a brush.

Heat control 14 is preferably connected to heater 30 to allow the user to manipulate or control the temperature in reservoir 9.

Housing 5 preferably has aeration outlets 16 and fluid jet ports or outlets 17. Aeration outlets 16 are preferably disposed along bottom wall 6 of reservoir 9 and are preferably suitable to introduce air into a fluid in reservoir 9. Aeration outlets 16 can alternatively be disposed in any of a variety of positions along bottom wall 6 and/or sidewalls 7 to provide for different air flow patterns or therapeutic bubbling effects in the fluid. Fluid outlets 17 are preferably disposed at a forward portion of reservoir 9. Fluid outlets 17 preferably facilitate pumping and/or recycling fluid in reservoir 9. Fluid outlets 17 can be adjustable, such as pivotally mounted, so that a user can alter the direction of flow of the fluid in reservoir 9. Additionally, fluid outlets 17 can have nozzles 18 that are adjustable for varying the turbulence of the fluid that is exhausted from the outlets. One or more fluid inlets 19 are preferably disposed in bottom wall 6. As with fluid outlets 17, fluid inlets 19 are preferably part of fluid transport assembly 65 and facilitate in pumping and/or recycling fluid in reservoir 9.

Housing 5 preferably has a number of surface projections or massage nodules 20 as is shown clearly in FIG. 2. These nodules 20 preferably extend from bottom wall 6 for added comfort and massage. Housing 5 preferably also has a vibration mechanism for imparting a vibratory motion to bottom wall 6. It will be appreciated by those skilled in the art that any of the known methods suitable for generating a vibratory motion in a foot spa may be used in foot spa 1 and are within the scope of the present invention. For example, these methods include, but are not limited to, a motor driven shaft having an eccentric weight attached thereto and an unbalanced rocker arm.

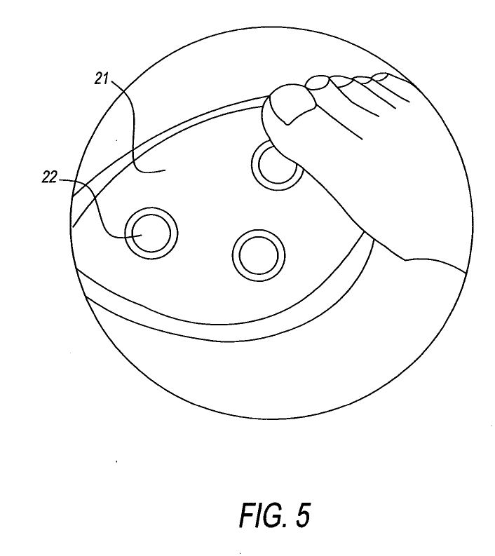

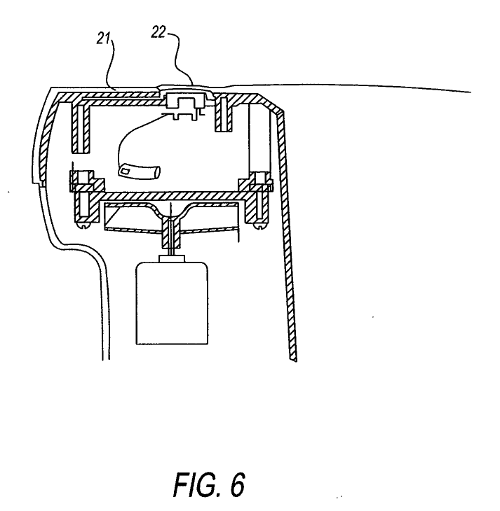

Referring to FIGS. 5 and 6, housing 5 preferably has a control panel 21. Control panel 21 preferably has a number of control buttons 22 for controlling the various systems associated with foot spa 1, including, for example, on/off and high/low buttons. This allows the user to separately use the various features of the foot spa 1 to achieve a desired therapeutic effect. Preferably, control buttons 22 are disposed on top wall 8 to facilitate easy access and/or operation via the user's toes, i.e., toe-touch controls. However, control panel 21 may also be disposed in alternative locations on foot spa 1. Additionally, a remote control can be used for controlling the functions of foot spa 1, as well as a tethered control device. The remote control and/or tethered control device can be used in conjunction with control panel 21 or can replace the control panel.

Housing 5 preferably has a cover 23 like that shown in FIGS. 1 and 2 that is preferably selectively and removably secured to top wall 8, for covering, at least partially, reservoir 9. Cover 23 preferably promotes containment of fluid in foot spa 1 when fluid is deposited therein. Cover 23 also preferably facilitates easy insertion and removal of the user's feet from foot spa 1.

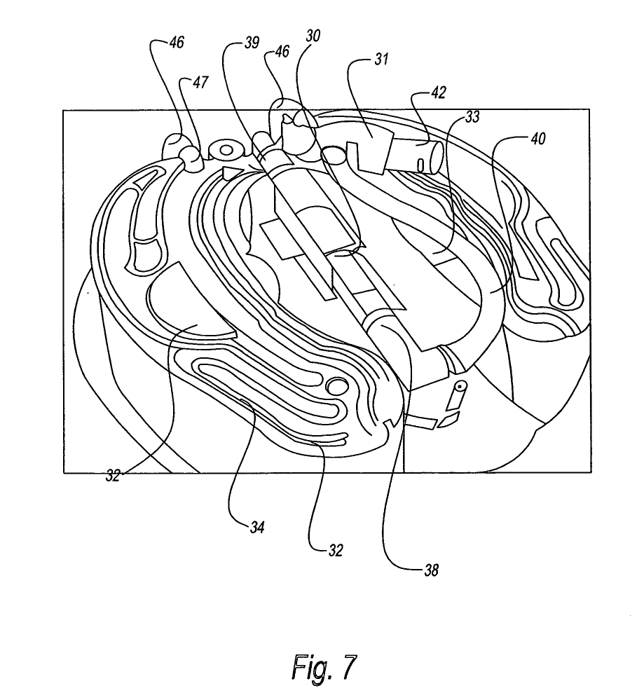

Referring to FIGS. 7 through 9, there is shown heater 30 and a pump 31. An inner undersurface 32 of housing 5 preferably has a recessed portion 33 (corresponding to raised portion 10), which partially houses heater 30. The fluid in reservoir 9 is preferably heated by a heater 30 and/or a heating wire 34. That is, fluid in reservoir 9 is preferably recycled via fluid transport assembly 65 so that the fluid is brought into thermal contact with heater 30, while heating wire 34 is preferably in thermal contact with housing 5 to warm bottom wall 6 and/or sidwalls 7, which walls, in turn, warm the fluid in reservoir 9.

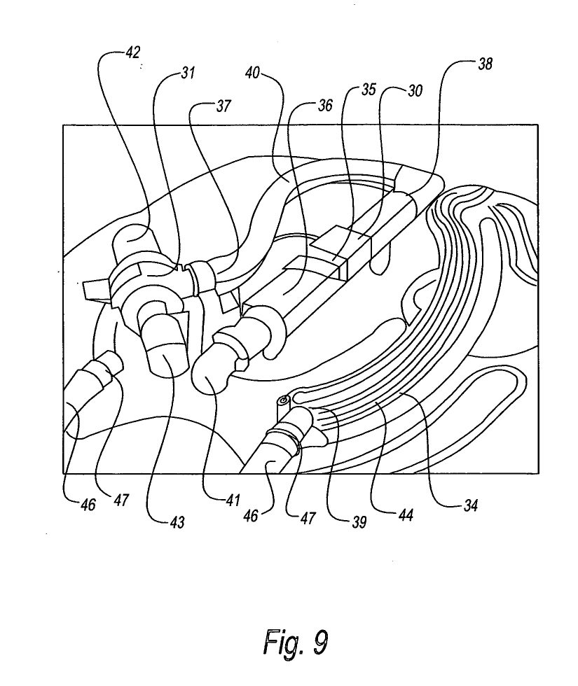

Heater 30 provides in-line heat or energy to the fluid as it is circulated or pumped into and out of reservoir 9. Heater 30 preferably has a heating chamber 35 integrally formed with an extrusion 36 adjacent to, and preferably parallel with, the heating chamber. As shown in FIG. 9, extrusion 36 has a heat generator 37 disposed therein. Preferably, the area of contact between heating chamber 35 and extrusion 36 is made of a material with high heat transfer properties to increase the efficiency of the heat transfer from heat generator 37 to the fluid flowing through heating chamber 35. In this embodiment, heating chamber 35 and extrusion 36 are made from aluminum. Preferably, heat generator 37 is a cal rod heater. Cal rod heat generator 37 typically is able to provide about 300 watts of energy, as compared to heating wire 34, which is limited to about 60 watts due to the lower temperature tolerance of housing 5.

Heating chamber 35 has a substantially cylindrical shape with a first end 38 and a second end 39. First end 38 is connected to a conduit 40 and second end 39 is connected to a fluid exhaust 41. Conduit 40 is connected to pump 31. Pump 31 has a pump motor 42 and a fluid intake 43. Fluid intake 43 and fluid exhaust 41 are in fluid communication with reservoir 9, which provides a fluid path of the fluid between the reservoir, heater 30 and pump 31. Preferably, fluid exhaust 41 is connected to fluid inlet 19 shown in FIG. 1 for exhausting the heated fluid from heating chamber 35 into reservoir 9.

Heating wire 34 is in thermal contact with undersurface 32, which preferably allows heat to transfer from the heating wire through the housing to heat the fluid in reservoir 9. Preferably, heating wire 34 is disposed in a serpentine-like shape, or other wave-like shape, along undersurface 32 to increase the contact area and improve the heat transfer between the heating wire and housing 5. Heating wire 34 is preferably disposed between flanges 44 formed along undersurface 32. More preferably, heating wire 34 is heat staked or otherwise adhered to undersurface 32 between flanges 44. Heating wire 34 transfers the energy or heat through housing 5, which limits the amount of energy or heat that can be transferred based upon the temperature tolerance of inner housing 5.

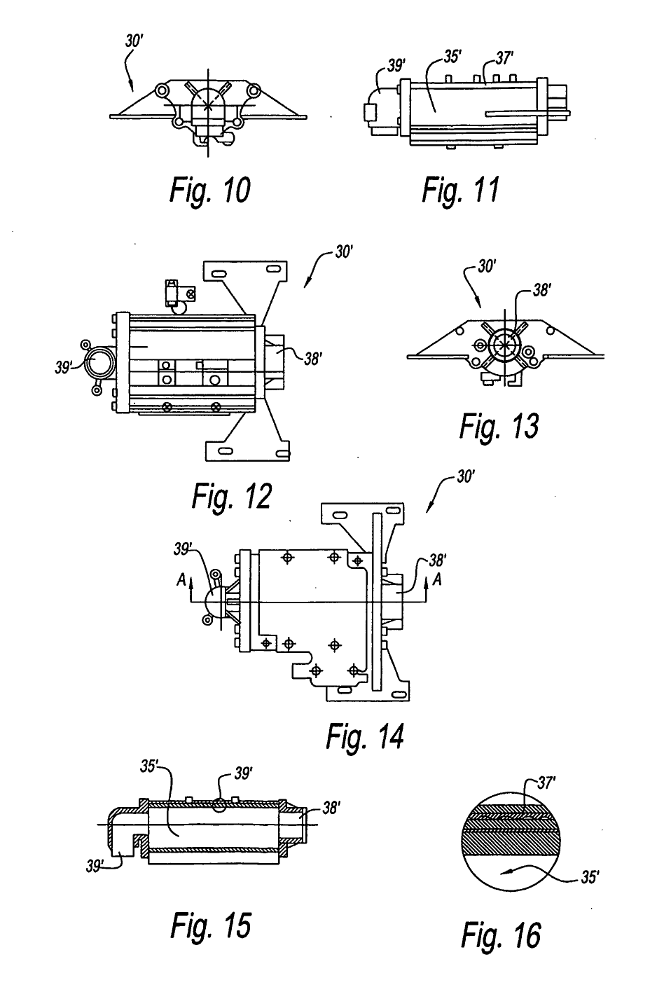

Referring to FIGS. 10 through 15, there is shown an alternative embodiment of the heater generally represented by reference numeral 30′. Heater 30′ preferably has a heating chamber 35′ and a heat generator 37′. Heater 30′ preferably also has a triangular-like shape, but alternative shapes including cylindrical could also be used. Heater 30′ preferably uses a cal rod heat generator 37′ connected to a mica card. As shown in FIG. 13, cal rod heat generator 37′ is disposed or sandwiched between layers to improve the heat transfer between the heater and heating chamber 35′. First end 38′ and second end 39′ are in fluid communication with pump 31 and reservoir 9 to provide for a path of circulation of the fluid into and out of reservoir 9.

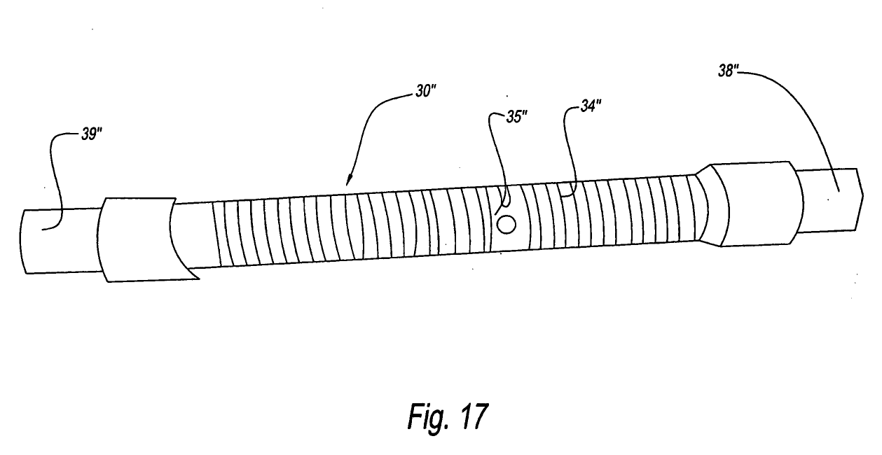

Referring to FIG. 17, there is shown another alternative embodiment of the heater, which embodiment is generally represented by reference numeral 30″. Heater 30″ preferably has a heating chamber 35″ and a printed resistive wire 34″, which transfers the heat to the fluid that flows through heating chamber 35″. First end 38″ and second end 39″ are in fluid communication with pump 31 and reservoir 9 to provide for a path of circulation of the fluid into and out of reservoir 9.

Accordingly, the present invention provides a method of heating fluid in a foot spa through an in-line heater 30. Heater 30 transfers heat to the fluid when the fluid is outside of housing 5. Heater 30 also transfers heat to the fluid as it flows through the heater assembly. Heater 30 is not required to transfer heat through housing 5 and can provide for more efficient heating of the fluid at higher temperatures and rates without the risk of damaging housing 5. While the embodiments shown use in-line heater 30 in conjunction with heating wire 34, the present invention also contemplates the use of the heater assembly by itself.

Turning now to the operation of foot spa 1, fluid deposited in the foot spa is optionally circulated by the fluid transport assembly in the housing. The pump preferably draws fluid deposited in the reservoir into the pump through an inlet and expels fluid into the reservoir via a “jetting” action through fluid jets (one shown in FIG. 1, any number may be included). The fluid jets can have multiple outlets that may be selectively positioned in a vertical and/or axial orientation by the user and directed in a desired direction. The pump used by the foot spa may have any number or variety of pumps suitably sized and rated for application in the foot spa of the present invention.

In an aspect of the present invention, the reservoir is heated by a heater assembly and a heating wire. The heating wire is in thermal contact with the undersurface of the bottom wall, which allows heat transfer from the heating wire through the bottom wall of the housing to heat fluid in the reservoir. Preferably, the heating wire is disposed in a serpentine-like shape, or other wave-like shape, along the undersurface of the bottom wall to increase the contact area and improve the heat transfer between the heating wire and the housing. The heating wire is preferably disposed between flanges formed along undersurface of the bottom wall. More preferably, heating wire is heat staked or otherwise adhered to undersurface of the bottom wall between flanges.

The heating wire transfers energy or heat through the housing, which may limit the amount of energy or heat that can be transferred based upon the temperature tolerance of the housing. Therefore, an in-line heater assembly is preferably included to provide in-line heat or energy to the fluid as it is circulated or pumped into and out of reservoir. In-line heater assembly has a heating chamber integrally formed with an extrusion adjacent to, and preferably parallel with, the heating chamber. The extrusion has a heater disposed therein. Preferably, the area of contact between heating chamber and extrusion is made of a material with high heat transfer properties to increase the efficiency of the heat transfer from the heater to the fluid flowing through heating chamber. In this embodiment, the heating chamber and the extrusion are made from aluminum. Preferably, the heater is a cal rod heater. The cal rod heater typically is able to provide about 300 watts of energy, as compared to the heating wire type heater that is limited to about 60 watts due to the lower temperature tolerance of the housing.

In another aspect of the present invention, foot spa 1 preferably can have an aeration system with a fluid circulation network having the pump discussed above, and one or more venturi mixers, all preferably retained substantially in the housing. For example, referring to FIG. 1, foot spa 1 can have one or more air conduits 45 that are in fluid communication with a source of air 46 flow, such as an air pump. One or more air conduits 45 are connected to air exhausts 47, which are in fluid communication with reservoir 9. Preferably, air exhausts 47 are connected to aeration outlets 16. Also, the circulation network can have aeration outlets opening into reservoir 9. Air is preferably drawn into foot spa via one or more air inlet(s) located on the bottom of the foot spa 1 and/or via one or more air conduits 45, with fluid being drawn from the reservoir via fluid inlet 19.

Air and fluid is provided to the venturi mixers by a network of pipes or in connection in air/fluid communication with the air and fluid inlets. The fluid/air mixture is routed to the aeration outlets 16 for the optional provisioning of invigorating air bubbles into reservoir 9.

In the embodiment of FIGS. 1 through 6, control switches 22, as well as roller actuator 50 are preferably used to control the functions of foot spa 1. For example, one button can be used to control on/off (i.e., activation/deactivation) of foot spa 1 and another button can be used to control the activation/deactivation of the fluid jets, heater, and/or aerating system.

Roller actuator 50 may be operated to control the operation of the foot spa 1 among a number of operational modes. For example, a user may selectively rotate roller actuator 50 to cycle between (1) a fluid jet and heated mode, (2) a fluid jet and air bubble mode, and (3) a heated, fluid jet, and air bubble mode. It should be appreciated, however, that the particular functions invoked in each of the exemplary modes (1)-(3) may be varied in number and combination of features, including varying the number of modes.

In an aspect of the present invention, control switches 22 are covered by an at least partially elastic, pliable material that is preferably soft to the touch. The elastic cover preferably seals the mechanical and/or electrical components of control switches 22 from moisture and other environmental concerns such as dust and dirt. This aspect of the present invention is provided for prolonging the operational life and operation of foot spa 1.

In another aspect of the present invention, roller actuator 50 is covered in an soft elastic material, similar to that enveloping control switches 22. This aspect of the present invention also provides enhanced operational control of foot spa 1.

In a significant aspect hereof, the control switches 22 and roller actuator 50 may be manipulated (i.e., pushed and turned, respectively) by a user's foot. Accordingly, a user need not bend over to control the operational features of foot spa 1. In a preferred embodiment, all of the functions of foot spa 1 may be easily and conveniently accessed and controlled with a user's foot.

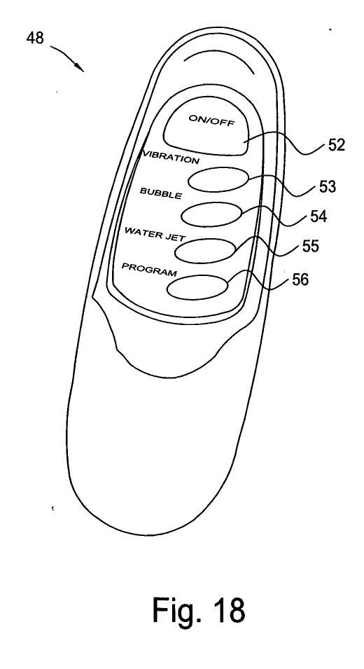

In another aspect of the present invention, operation of the foot spa is greatly eased by remote control 48, such as that shown in FIG. 18. Remote control 48 has an internal power source (preferably batteries) and associated electronic circuitry for wirelessly transmitting a control signal to a receiver 49 located in or on-board foot spa 1. Remote control 48 enhances operation of foot spa 1 since the controls necessary to activate, control, and deactivate the various operational functions of the foot spa, are accessed and conveniently packaged in the remote control unit. Thus, one using foot spa 1 can control the various operations of the foot spa without impeding the relaxing context induced by operation of the foot spa. Wireless communication between remote control 48 and foot spa 1 may be accomplished using infrared, radio frequency (RF), sonic, or any other wireless communication format using any applicable protocol. Control panel 21 preferably has the controls for controlling the various features of foot spa 1 of the present invention. Likewise, remote control 48 preferably has the controls for controlling the various features of foot spa 1 either directly or indirectly via the controls of control panel 21.

Referring to FIG. 18, function controls located on remote control 48, and thus controlling associated functions of foot spa 1 include, for example, an on/off control 52, vibration control 53, bubble control 54, fluid-jet control 55, and program control 56.

In brief, on/off control 52 is sequentially depressed to activate/deactivate operation of foot spa 1. Vibration control 53 is sequentially depressed to activate/deactivate the vibratory mechanism of foot spa 1. Bubble control 54 is sequentially depressed to activate/deactivate the aerated bubbling function of foot spa 1. Fluid-jet control 55 is sequentially depressed to activate/deactivate the fluid “jetting” function of foot spa 1. Thus, complete control of the functional operation of foot spa 1 can be accomplished without having to manipulate controls located on the foot spa. Activation or deactivation of a particular function commences generation of a control signal that is transmitted to and received by receiver 49. The control signal received by the receiver is processed to effectuate the associated function.

In another aspect of the present invention, program control 56 may be sequentially depressed in order to activate/deactivate an automated, programmed sequence of foot spa functions (e.g., vibration, bubble, and fluid-jet). The program may be predetermined (i.e., factory default) or selectively programmed by a user. In either event, the program may be associated with a time component that determines the length of time the program operates.

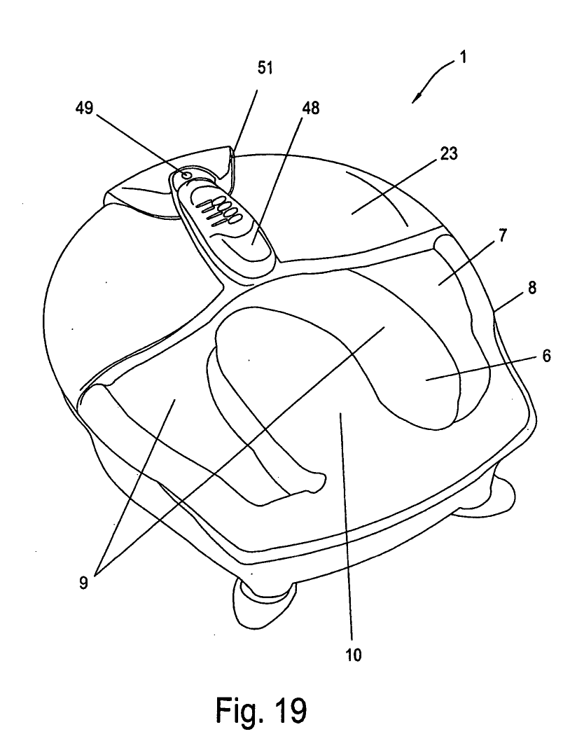

Referring to FIG. 19, remote control 48 may be adapted to reside in a remote control unit receptacle 50 disposed on or in foot spa 1. Remote control 48 can be selectively disassembled for facilitating access to, for example, batteries located therein and for replacement of the same. Advantageously, remote control 48 is assembled in a fluid tight fashion to make the remote control resistant to the penetration of fluid. Also, remote control 48 preferably floats when disposed in fluid.

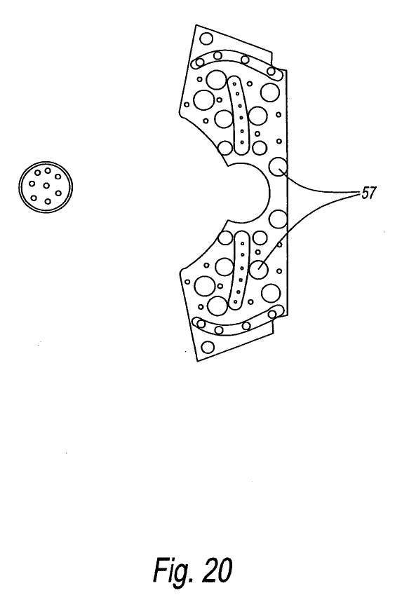

FIG. 20 depicts foot bed inserts 57 that cooperate with foot spa 1 to provide a cushioned massage. Foot bed inserts 57 are preferably constructed of a rubberized material that is resistant to tearing and bacterial growth. As shown, foot bed inserts 57 can have holes that align with air outlet holes located in the bottom wall of the housing. In this manner, air expelled from the air outlet holes will not be blocked by foot bed inserts 57.

In another aspect of the present invention, cover 23 can have an array of massage fingers 58 as shown in FIG. 1. Massage fingers 58 may be used to massage the bottom and/or sides of the user's feet. As shown, there can also be preferably a number of drainage holes 59 throughout the array of massage fingers 58 for allowing fluid to drain through cover 23 into reservoir 9 instead of collecting on a top surface thereof.

Also, as shown in FIGS. 1 and 2, a loofah 60 can be disposed on cover 23 over the array of massage fingers 58. Loofah 60 preferably has a sponge made of fibrous skeleton of the fruit of a loofah (i.e., gourd). Although loofah 60 is preferably made of an organic material, loofah 60 may be at least partially constructed of synthetic material.

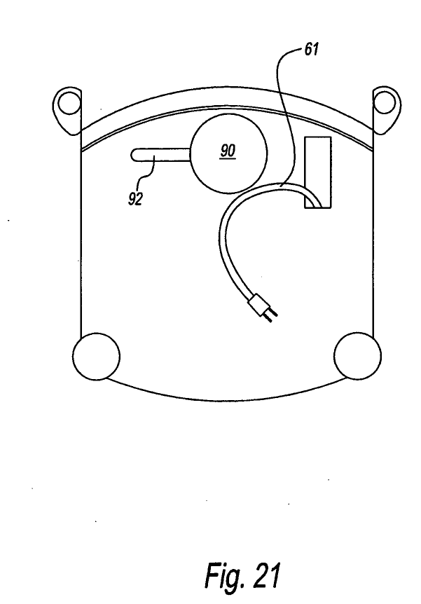

Still further, as shown in FIG. 21, foot spa 1 can have an electrical cord 61 that is preferably stowed in an inner chamber of housing 5. That is, cord 61 may be retracted into housing 5 for storage in between uses of foot spa 1. Cord 61 is preferably wound around a reel (not shown) that is geared to manually operated reel 90 located on an exterior bottom surface of housing 5. In order to better facilitate a low minimum required clearance height, a handle portion of reel 90 is foldable. In this manner, handle 92 may be folded flat during use and storage of foot spa 1 and unfolded for grasping when reeling cord 61 into housing 5.

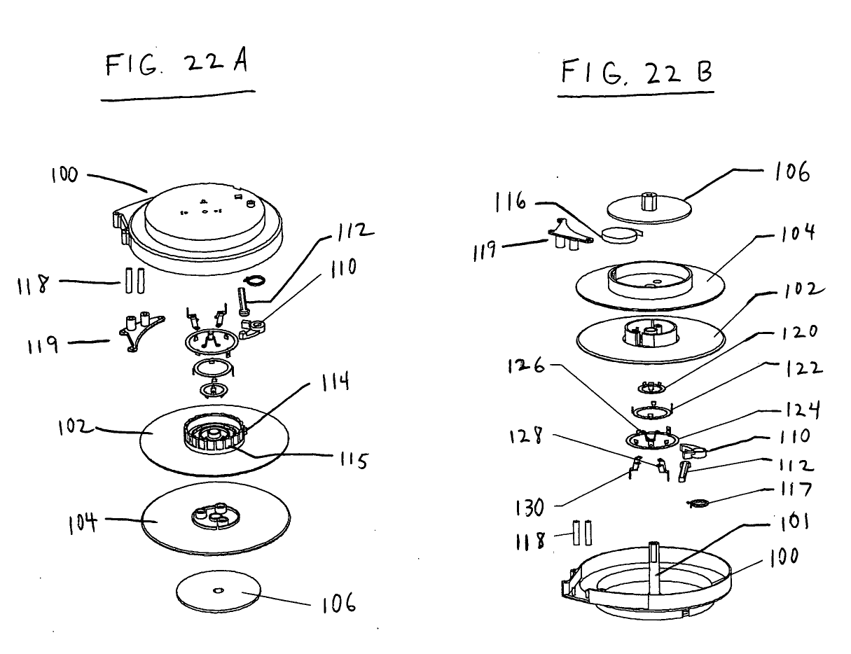

An exemplary embodiment of this cord reel 90 is shown in FIGS. 22A and 22B. FIG. 22A shows the cord reel 90 from the top down. FIG. 22B shows the cord reel 90 from the opposite view. The cord reel 90 preferably includes a cord reel housing 100, a top disc 102, a bottom disc 104 and a cover 106. In a preferred embodiment, these elements 100, 102, 104, 106 are fabricated from nylon. However, other appropriate materials may be utilized.

Within the housing is a pawl system that enables the cord to be selectively locked at a multitude of positions to enable virtually any length of cord 61 to be utilized. The pawl system includes a clutch pawl 110, a button 112, a notch member 114 and a wound spring 116, preferably made of stainless steel. The cord 61 is wrapped around a cord post 101 within the cord reel housing 100. The wound spring 116 biases the cord toward the retracted position. A user pulls the cord 61 and the clutch pawl 110 locks into one of many notches 115 in the notch member 114. This temporarily prevents the backward motion of the cord 61 toward the retracted position. To release the cord 61, the button 112 is depressed against the biased position of a release spring 117. This releases the cord 61, which then retracts toward the fully retracted position. A cord roller guide 118 prevents the cord from rubbing and, thereby, the wearing down of the cord 61. A roller guide cover 119 can be used to support and protect the roller guide 118 and cord 61.

Also within the cord reel housing 100 are preferably electrical contact brass plates including ground 120, neutral 122 and live 124, as well as electrical contact phosphorated bronze plates including ground 126, neutral 128 and live 130.

It should be also appreciated that the function controls discussed above are exemplary of the foot spa of the present invention and do not preclude the inclusion, exclusion, and combination of other foot spa function controls.

It should be understood that the foregoing description is only illustrative of the present invention. Various alternatives and modifications can be devised by those skilled in the art without departing from the present invention. For example, an important aspect of the present invention is the inclusion in one foot spa device the many numerous features discussed in detail above. Accordingly, the present invention is intended to embrace all such alternatives, modifications and variances.

What is claimed is:

1. A foot spa comprising:
a housing having a foot supporting bottom wall with sidewalls extending upwardly therefrom to form a reservoir for receiving and retaining a fluid;
a fluid transport assembly disposed in said housing and being operatively connected to a fluid inlet disposed in said reservoir and a fluid outlet spaced a distance from said bottom wall of said reservoir, whereby fluid exiting said fluid outlet flows into said reservoir;
one or more heaters associated with said housing; and
a retractable power cord for safe transport and/or storage of the foot spa.

2. A foot spa according to claim 1, wherein
said retractable power cord further comprises a wound spring to bias said cord toward a retracted position.

3. A foot spa according to claim 2, further comprising
a pawl and a notch member to enable said cord to be temporarily prevent the backward motion of the cord toward the retracted position.

4. A foot spa according to claim 2, further comprising
a cord roller guide to guide said cord as it is retracted or extended.

5. A foot spa according to claim 2, further comprising
a cord reel housing to protect said cord from wearing.

6. A foot spa according to claim 3, further comprising
a button to release said pawl from said notch member to enable said cord to move toward the fully retracted position.

7. A foot spa according to claim 1, further comprising
an ion and/or ozone emitter for emitting ions into said fluid.

8. A foot spa according to claim 1, further comprising
a controller for controlling any of a variety of operative functions associated with said foot spa, wherein said variety of operative functions can be selected from a group consisting of a heating action, a jetting action, a vibratory action, or any combination thereof.
